(19) United States
(12) Patent Application Publication
(10) Pub. No.: US 2010/0085494 A1
(43) Pub. Date: Apr. 8, 2010

(54) In-vehicle apparatus

(75) Inventors: Yukio Shimizu, Kobe-shi (JP); Masataka Sakata, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/458,275

(22) Filed: Jul. 7, 2009

(30) Foreign Application Priority Data
Oct. 3, 2008 (JP) 2008-258103

(51) Int. Cl. H04N 5/64

(52) U.S. Cl. 348/837; 348/E05.128

(57) ABSTRACT

An in-vehicle apparatus such as a navigation system can be installed in an instrument panel in a vehicle, and includes a main unit, a display for displaying video output from the main unit, and a holder frame for holding the display and for adjustably connecting to the main unit. The holder is connected, at a predetermined position, to a finisher having an opening for allowing viewing of the display. As a result, the display is placed at a predetermined position relative to the finisher.

### BACKGROUND OF THE INVENTION

1. Field of the Invention

The present invention relates to an in-vehicle apparatus to be installed in a vehicle.

2. Description of the Background Art

Various types of in-vehicle apparatuses have been proposed in the past to be installed in instrument panels of vehicles (refer to, for example, Japanese Laid-Open Disclosure Public Patent Bulletin No. JP10-129362 A). Among such in-vehicle apparatuses, one of well-known apparatus is, for example, a unit comprising a main unit and a display unit that shows information output from the main unit. After an in-vehicle apparatus is installed in the instrument panel, a finisher, which is a decorative panel to fill or cover the gap between the instrument panel and the main unit and thus to improve the appearance, is attached. The finisher has an opening for allowing viewing of the display unit.

When the in-vehicle apparatus is installed in the instrument panel, the position of the main unit is adjusted relative to the instrument panel. However, positioning accuracy of the display unit relative to its corresponding main unit is different for each installation. Especially, when the display unit is a component separated from the main unit and movable relative to the main unit, such individual difference in positioning accuracy is noticeable. Therefore, even when the position adjustment of the main unit is appropriate relative to the instrument panel, there is the case in which the display unit is not placed at an appropriate position.

Moreover, in the case in which the display unit is movable relative to the main unit, it is necessary to prevent the display unit from contacting the opening of the finisher when the display unit moves. Therefore, in consideration of difference in position of each display unit relative to its corresponding main unit, the opening needs to be designed larger than an actual size of the display unit. However, a larger opening results in larger gap between the display unit and the opening. As a result, the appearance is impaired when the apparatus is installed in a vehicle.

### SUMMARY OF THE INVENTION

According to one aspect of the invention, an in-vehicle apparatus includes: a main unit; a display unit for displaying information output from the main unit; and a holder for holding the display unit and for connecting position-adjustably to the main unit, wherein the holder connects, at a predetermined position, to a finisher having an opening for allowing viewing of the display unit.

The position of the holder is adjustable relative to the main unit but is constant relative to the finisher. Therefore, even if appropriate position of each display unit relative to its corresponding main unit is different, the position of the display unit held by the holder can be constant relative to the finisher. Accordingly, the display unit can be placed at the optimal position relative to the opening of the finisher.

According to an aspect of the invention, an in-vehicle apparatus includes: a main unit adjustably connected to an installation part in a vehicle so that the position of the main unit is adjustable; a display unit for displaying information output from the main unit; and a holder for connecting position-adjustably to the main unit, wherein the position of the holder is constant relative to the installation part in the vehicle.

While the position of the main unit is adjustable relative to the installation part in a vehicle, the position of the holder is constant relative to the installation part in the vehicle although the position of the holder is adjustable relative to the main unit. Therefore, even if the appropriate position of each display unit relative to its corresponding main unit is different, the display unit held by the holder can be constant relative to the installation part in the vehicle.

According to another aspect of the invention, a holder for holding a display of an in-vehicle apparatus installed in a vehicle includes: a first joint for connecting position-adjustably to a main unit of the in-vehicle apparatus; and a second joint for connecting to a finisher having an opening for allowing viewing of a display unit, at a predetermined position relative to the finisher.

Because the position of the holder is adjustable relative to the main unit, the position of the display unit held by the holder can be constant relative to the finisher even if the appropriate position of each display unit relative to its corresponding main unit is different.

Therefore, it is an object of the invention to position a display unit at a predetermined position when an in-vehicle apparatus is installed in a vehicle.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is an explanatory illustration showing the installation in a vehicle of a navigation apparatus, which is an in-vehicle apparatus according to one embodiment.

FIG. 2 shows a front view of the navigation apparatus.

FIG. 3 shows a sectional view of the periphery of the navigation apparatus after the navigation apparatus is installed in an instrument panel.

FIG. 4 shows position adjustment of the holder frame.

### DESCRIPTION OF THE PREFERRED EMBODIMENTS

Hererinbelow, an embodiment of the invention is explained, referring to the accompanying drawings.

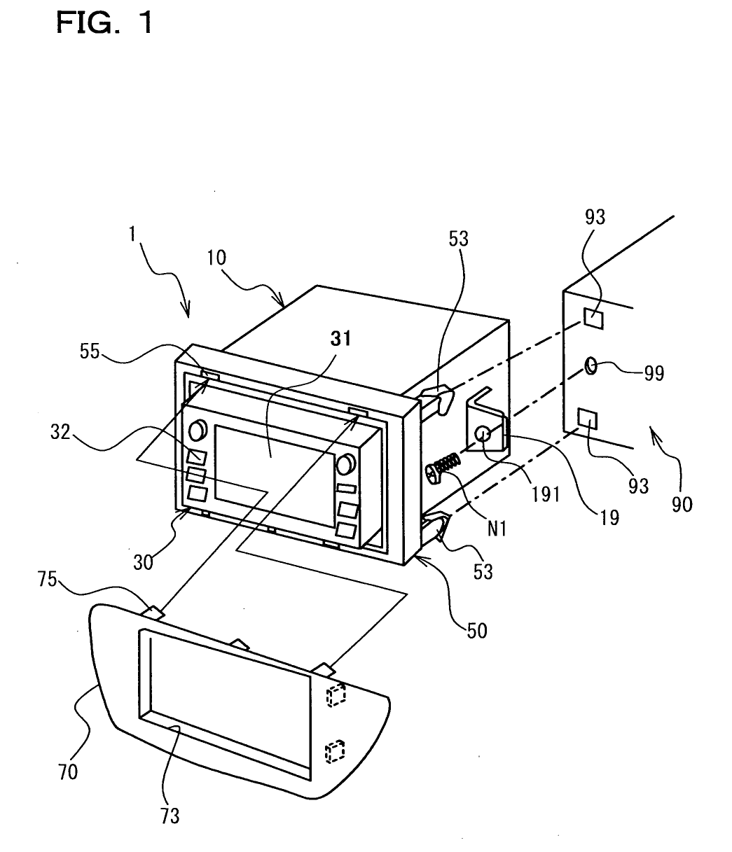

FIG. 1 is an explanatory illustration showing the installation of a navigation apparatus that is an in-vehicle apparatus of an embodiment of the invention. As shown in FIG. 1, a navigation apparatus 1 comprises a main unit 10, a display unit 30 on the front of the main unit 10, and a holder frame 50 that is a component for holding the display unit 30. The holder frame 50 is placed between the main unit 10 and the display unit 30.

The main unit 10 incorporates a motherboard for enabling navigation function, and the motherboard is mounted with CPU, ROM, RAM, and other necessary units. The main unit 10 outputs navigation video and other information to be shown on the display unit 30.

A fixing bracket 19 is attached on each of the right and left sides of the main unit 10. The fixing brackets 19 are for fixing the main unit 10 to the instrument panel 90. Each of the fixing brackets 19 has a through-hole 191. The size of the through-hole 191 is bigger than a screw N1, and the screw N1 can be inserted through the hole. In addition, the screw N1 is screwed together with a screw hole 99 in the installment panel 90. By being screwed together with the screw hole 99 though the through-hole 191, the main unit 10 is connected with the instrument panel 90 to be installed in a vehicle. However, since the size of the through-hole 191 is bigger than the shaft of the screw N1, the position of the main unit 10 is not necessarily constant relative to the instrument panel 90. In other words, the position of the main unit 10 is free to be placed adjustable relative to the instrument panel 90 within the range of the clearance between the through-hole 191 and the screw N1, which means the position of the main unit 10 is adjustable relative to the installment panel 90.

The display unit 30 is a component separated from the main unit 10 and is equipped, on the front, with a display 31 for displaying navigation video and other information output from the main unit 10. In addition, the display unit 30 includes operation buttons 32 with which users operate the navigation apparatus 1, adjacent to the display 31. Moreover, the display unit 30 is connected on a tiltable basis to the main unit 10. More specifically, the bottom head of the display unit 30 slides forward in the viewing direction of the display 31, and the display unit 30 glides, tilting relating to the main unit 10. The tilt of the display unit 30 is ensured by a shaft (not illustrated) of which an edge is connected to the bottom head of the display unit 30 moving backwards and forwards from the main unit 10.

As the display unit 30 tilts and moves, the front face of the holder frame 50, which is hidden in the state of FIG. 1, is exposed. On the front side of holder frame 50, a slot (not illustrated) is provided for inserting and removing a readable recording medium. Users can make the slot exposed by tilting and moving the display unit 30.

The holder frame 50 is made from synthetic resin in the form of a frame with a backboard. The holder frame 50 holds the display unit 30 on a tiltable basis. More specifically, grooves (not illustrated) are longitudinally formed on the inner side of the holder frame 50, and rollers (not illustrated) for rolling in the grooves are attached on the both sides of the top end of the display unit 30. The rolling of the rollers in the grooves of the holder frame 50 enables the holder frame 50 to hold the display unit 30 on a tiltable basis.

In addition, the holder frame 50 is fixed on the front of the main unit 10. The holder frame 50 has insertion parts 53 protruding toward the backside of the holder frame 50. Two of the insertion parts 53 are attached each on the right and left sides of the holder frame 50 (there are four insertion parts 53 in total). The numbers and the position of the insertion parts can be changed as desired. The insertion parts 53 are fit in joint holes 93 on the instrument panel 90. The position of the holder frame 50 is determined at the predetermined position relative to the instrument panel 90 by the fit of the insertion parts 53 in the joint holes 93. Moreover, the holder frame 50 has multiple engagement holes 55 for engaging with the finisher 70. The engagement holes 55 are provided on the periphery of the display unit 30.

The finisher 70 is for covering the periphery of the display unit 30. The finisher 70 has an opening 73 for allowing the display unit 30 to be exposed so that users can view the display 31 on the display unit 30 through the opening 73. As the display unit 30 tilts, a part of the display unit 30 enters the opening 73. Therefore, the size of the opening 73 is designed not to interfere with the display unit 30 in the state of tilting. The finisher 70 has multiple engaging hooks 75 for engaging with the engagement holes 55 on the holder frame 50. The holder frame 50 is connected to the finisher 70 at the predetermined position by the engagement holes 55 being engaged with the engaging hooks 75. For ease of illustration, a part of finisher 70 is not illustrated in FIG. 1.

The instrument panel 90 holds the navigation apparatus 1, situated between the driver's and passenger's seats in a vehicle. The instrument panel 90 is an installation part to which the navigation apparatus 1 is installed.

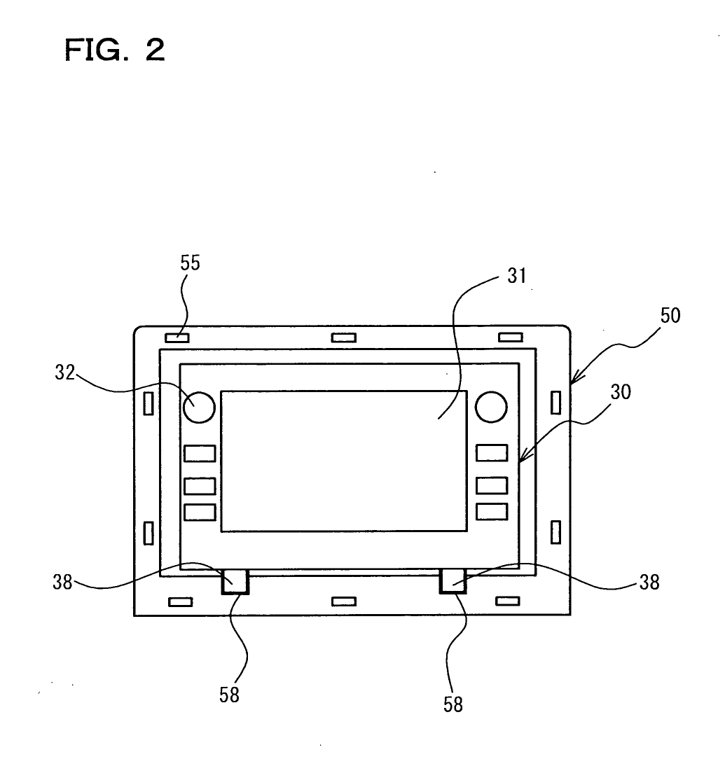

FIG. 2 shows a front view of the navigation apparatus 1. As shown in FIG. 2, protrusions 38 are formed on the end face on the lower side of the display unit 30. Concavities 58 are formed on the holder frame 50 at the positions corresponding to the protrusions 38. The engagement of protrusions 38 and concavities 58 regulates the position of the holder frame 50 relative to the display unit 30. Moreover, since the display unit 30 tilts and moves, clearance for allowing the tilt and movement is given between protrusions 38 and concavities 58.

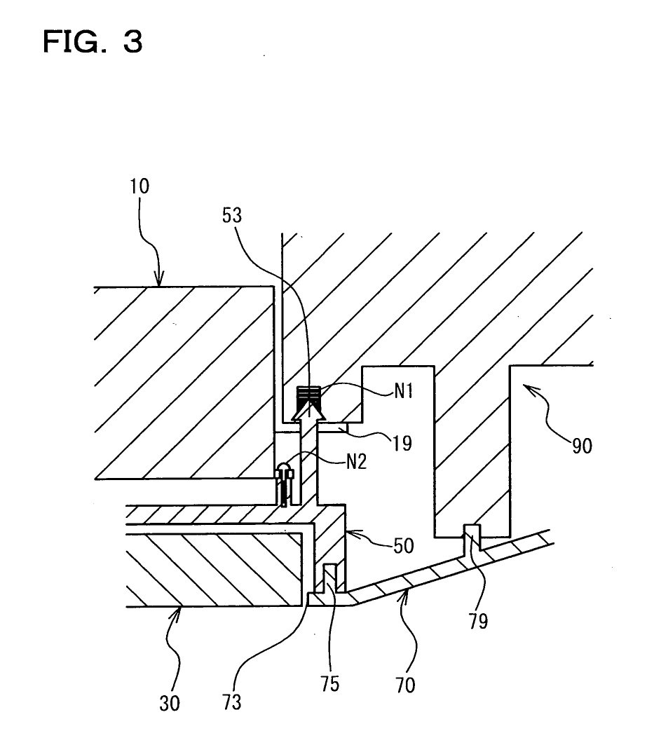

The explanation herein provided is of the navigation apparatus 1 being assembled to the instrument panel 90. FIG. 3 is a sectional view showing the circumference of the navigation apparatus 1 being assembled to the instrument panel 90. There is a mechanism between the outer side of the display unit 30 and the inner side of the holder frame 50, for holding the display unit 30 so that the display unit 30 can tilt relative to the holder frame 50. However, the mechanism is not illustrated. Another mechanism between the main unit 10 and the display unit 30 for allowing the display unit 30 to tilt is not illustrated either.

The finisher 70 includes engaging hooks 75 for engaging with the holder frame 50 and engaging hooks 79 for engaging with the instrument panel 90. Since the instrument panel 90 and the finisher 70 are fixed together by the engaging hooks 79, the position of the finisher 70 is fixed at a predetermined position relative to the instrument panel 90. As a result, the position of the opening 73 is constant relative to the instrument panel 90.

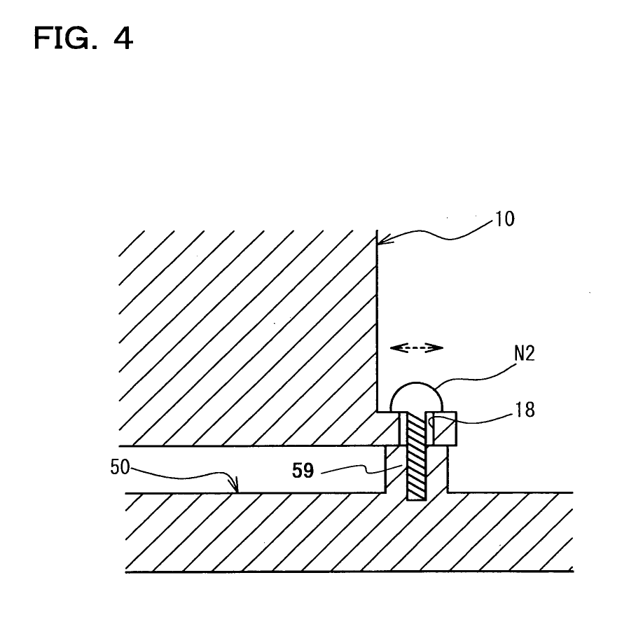

Position adjustment of the holder frame 50 is herein explained. FIG. 4 shows the position adjustment of the holder frame 50. As shown in FIG. 4, the main unit 10 is connected with the holder frame 50 by screws N2. The screw holes 18, on the main unit 10, to which the screws N2 are inserted, are bigger than the threaded shaft of the screws N2 in size. Moreover, the screws N2 are screwed together with threaded screw holes 59 which are formed on the back side of the holder frame 50 to serve as joints with the main unit 10. Therefore, the position of the holder frame 50 is adjustable relative to the main unit 10. Accordingly, since the holder frame 50 is connected to the finisher 70 at the predetermined position, the display unit 30 can be placed at the predetermined position relative to the finisher 70 even if appropriate position of each display unit relative to its corresponding main unit is different. Further, the display unit 30 can be placed at the predetermined position relative to the instrument panel 90.

Since the display unit 30 can be placed at the predetermined position relative to the finisher 70, the display unit 30 can be placed at an appropriate position relative to the opening 73 even in the case in which the opening 73 of the finisher 70 is designed to be smaller than otherwise. Moreover, when the display unit 30 tilts, and a part of the display unit 30 enters the opening 73, contact of the display unit 30 with the opening 73 can be prevented. Consequently, the gap between the display unit 30 and the opening 73 can be smaller than otherwise, which improves the appearance of the navigation apparatus 1 installed in a vehicle.

It should be understood that the preferred embodiment of in-vehicle apparatus described and illustrated herein is only a navigation apparatus but it may be audio or other in-vehicle apparatuses including a display.

While the invention has been shown and described in detail, the foregoing description is in all aspects illustrative and not restrictive. It is therefore understood that numerous other modifications and variations can be devised without departing from the scope of the invention.

What is claimed is:

1. An in-vehicle apparatus for installation in a vehicle, the apparatus comprising:
a main unit that outputs information to be displayed;
a display for displaying information output from the main unit; and
a holder for holding the display, the holder being adjustably connectable to the main unit, the holder being connectable, at a predetermined position, to a finisher having an opening for allowing viewing of the display.

2. The in-vehicle apparatus according to claim 1, wherein:
the display is connected to the main unit so as to move in a predetermined direction; and
the holder holds the display in order that the display may move in the predetermined direction.

3. The in-vehicle apparatus according to claim 2, wherein
the display enters the opening of the finisher by moving in the predetermined direction.

4. The in-vehicle apparatus according to claim 1, wherein
the main unit comprises a joint for adjustably connecting to an installation part in the vehicle.

5. The in-vehicle apparatus according to claim 4, wherein
the joint is a through hole to be connected to the installation part by a threaded connector having clearance with respect to the through hole.

6. The in-vehicle apparatus according to claim 1, wherein
the main unit comprises a first joint; and
the holder comprises a second joint, wherein
the first joint and the second joint are connectable to each other so that the holder is adjustably connected to the main unit.

7. The in-vehicle apparatus according to claim 6, wherein
the first joint is a through hole;
the second joint is a threaded hole; and
the through hole is connectable to the threaded hole by a threaded connector having clearance with respect to the through hole.

8. The in-vehicle apparatus according to claim 1, wherein
the holder comprises a component that regulates a position of the display by engaging with a part of the display.

9. An in-vehicle apparatus for installation in a vehicle, the apparatus comprising:
a main unit that outputs information to be displayed and is adjustably connectable to an installation part in the vehicle;
a display for displaying the information output from the main unit; and
a holder for holding the display, the holder being adjustably connectable to the main unit, a position of the holder being adjustable to a constant position relative to the installation part.

10. The in-vehicle apparatus according to claim 9, wherein
the display is connected to the main unit so as to move in a predetermined direction; and
the holder holds the display in order that the display may move in the predetermined direction.

11. The in-vehicle apparatus according to claim 10, wherein
the holder is connected, at a predetermined position, to a finisher having an opening that fits with clearance around the display and allows viewing of the display.

12. The in-vehicle apparatus according to claim 11, wherein
the display enters the opening of the finisher by moving in the predetermined direction.

13. The in-vehicle apparatus according to claim 9, wherein
the main unit comprises a joint for adjustably connecting to the installation part

14. The in-vehicle apparatus according to claim 13, wherein
the joint is a through hole to be connected to the installation part by a threaded connector having clearance with respect to the through hole.

15. The in-vehicle apparatus according to claim 9, wherein
the main unit comprises a first joint; and
the holder comprises a second joint, wherein
the first joint and the second joint are connectable to each other so that the holder is adjustably connected to the main unit and the position of the holder is constant relative to the installation part.

16. The in-vehicle apparatus according to claim 15, wherein
the first joint is a through hole;
the second joint is a threaded hole; and
the through hole is connectable to the threaded hole by a threaded connector having clearance with respect to the through hole.

17. The in-vehicle apparatus according to claim 9, wherein
the holder comprises a component that regulates the position of the display by engaging with a part of the display.

18. A holder for holding a display of an in-vehicle apparatus for installation in a vehicle, the holder comprising:
a first joint for adjustably connecting to a main unit of the in-vehicle apparatus; and
a second joint for connecting, at a predetermined position, to a finisher having an opening that fits with clearance around the display and allows viewing of the display.

19. The holder according to claim, 18 further comprising a component that regulates a position of the display by engaging with a part of the display.
